(19) United States
(12) Patent Application Publication
(10) Pub. No.: US 2011/0310597 A1
(43) Pub. Date: Dec. 22, 2011

(54) SOLAR ENERGY GROUND LIGHT STRUCTURE

(75) Inventor: Ming Hsin Lu, Jhongli City (TW)

(73) Assignee: Maki Solar Technologies Inc., Jhongli City (TW)

(21) Appl. No.: 12/816,398

(22) Filed: Jun. 16, 2010

(51) Int. Cl. F21L 4/00; F24J 2/38

(52) U.S. Cl. 362/183; 126/600

(57) ABSTRACT

The present invention discloses a solar energy ground light structure. The solar energy ground light structure includes a shell, at least one solar energy plate, light-emitting diodes and an optical film plate. The shell has a bottom plate and a lateral plate. The solar energy plate and the light-emitting diodes are disposed on the bottom plate alternately. The optical film plate is disposed on the shell and has light-converging areas and light-diffusing areas. The solar energy plate is corresponding to the light-converging areas and the light-emitting diodes are corresponding to the light-diffusing areas. Therefore, the light-converging capacity of the solar energy ground light structure can be improved and the uniformity of the emitting light also can be enhanced.

### BACKGROUND OF THE INVENTION

1. Technical Field

The present invention relates to solar energy ground light structure, and more particularly to a solar energy ground light structure that improves the light-converging capacity and enhances the uniformity of the emitting light.

2. Description of Related Art

In recent years, global abnormal climate has brought about great loss in life and properties all over the world. This plus the fact that the draining natural resources cost increasingly, the governments have no choice but to actively advocate environmental protection, resource preservation and reduction of carbon emission, which are matters of human survival.

In response to the trend of worldwide environmentalism and policy to reduce carbon footprint, solar energy has become the most promising star energy. Therefore, various product powered by the sun have been developed. Therein, lamps with solar energy plates enjoy a strong market demand and thus highlight the use of solar energy.

A solar energy ground light is one of the lamps equipped with solar energy plates, and primarily comprises a light housing, solar energy plates, a light source and a pervious-to-light cover. The solar energy plates and the light source are settled inside the light housing while the pervious-to-light cover covers on the light housing. In use, such a solar energy ground light is typically inlaid into a ground surface or a wall surface with only the light-emitting surface exposed outside. Thus such solar energy ground lights, as being advantageous for taking no overground space, unaffecting landscape and requiring no additional power source, are extensively used on roads, in yards, in parks and in hospitals for illumination, guidance, indication, warning and decoration.

In operation, solar energy plates of the solar energy ground light convert the light energy received thereon into electric energy and then a light-emitting element is powered by the electric energy generated by the solar energy plates. In the solar energy ground light, the light-converging effect is in direct proportion to the superficies of the solar energy plates. That is, if it is desired to improve the light-converging capacity and in turn the power-generating capacity of the solar energy ground light, the solar energy plates have to be increased in area. However, doing so can directly lead to downsize light-emitting surface of the light-emitting element, namely to an overall weakened light-emitting intensity of the solar energy ground light. Hence, it would be desired to improve the light-converging capacity of a solar energy ground light without increasing the solar energy plates in superficies.

### SUMMARY OF THE INVENTION

The present invention provides a solar energy ground light structure, in which light-converging areas and light-diffusing areas are provided on an optical film plate, so as to increase the light-converging capacity of the solar energy ground light structure, thereby in turn improving the photoelectric conversion efficiency.

The present invention provides a solar energy ground light structure, in which light-converging areas of an optical film plate are positionally corresponding to the solar energy plates and light-diffusing areas of the optical film plate are positionally corresponding to light-emitting diodes, thereby enhancing the light-converging utilization rate, and thereby allowing more flexible photoelectric conversion and light distribution.

The present invention provides a solar energy ground light structure, in which an optical film plate serves to change a light-emitting angle, thereby improving the uniformity of the emitting light.

To achieve these and other effects of the present invention, the disclosed solar energy ground light structure comprises: a shell composed of a body and a pervious-to-light cover with an accommodating space defined therein, wherein the body has a bottom plate and a lateral plate; at least one solar energy plate and a plurality of light-emitting diodes alternately arranged on the bottom plate; and an optical film plate settled in the shell and having a plurality of light-converging areas and a plurality of light-diffusing areas, wherein each said light-converging area is corresponding to a respective said solar energy plate while each said light-diffusing area is corresponding to a respective said light-emitting diode.

By implementing the present invention, at least the following progressive effects can be achieved:

1. The optical film plate having the light-converging areas and the light-diffusing areas contributes to improve light-converging capacity and light-emitting uniformity of the solar energy ground light structure.

2. By the characteristic that the light-converging areas are corresponding to the solar energy plates and the light-diffusing areas are corresponding to the light-emitting diodes, the light-converging utilization rate can be improved.

3. The optical film plate serves to adjust the light-emitting angle, thereby improving the uniformity of the emitting light.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1A is a sectional view of a solar energy ground light structure according to a first embodiment of the present invention;

FIG. 1B is an enlarged view of a light-converging area of FIG. 1A;

FIG. 1C is an enlarged view of a light-diffusing area of FIG. 1A;

FIG. 2 is a top view of a solar energy ground light structure according to a second embodiment of the present invention;

FIG. 3A is a perspective view of a solar energy ground light structure according to a third embodiment of the present invention;

FIG. 3B is a perspective view of a solar energy ground light structure according to a fourth embodiment of the present invention;

FIG. 4A is a sectional drawing showing an optical film plate according to one aspect of the present invention;

FIG. 4B is a sectional drawing showing an optical film plate according to another aspect of the present invention;

FIG. 5 is a sectional view of a solar energy ground light structure according to another embodiment of the present invention;

FIG. 6 is a sectional view of a solar energy ground light structure according to another embodiment of the present invention;

FIG. 7 is a sectional view of a solar energy ground light structure according to still another embodiment of the present invention;

FIG. 8 is a sectional view of a solar energy ground light structure according to yet another embodiment of the present invention;

FIG. 9A is a sectional drawing showing an optical film plate according to a third aspect of the present invention;

FIG. 9B is a sectional drawing showing an optical film plate according to a fourth aspect of the present invention; and

FIG. 9C is a sectional drawing showing an optical film plate according to a fifth aspect of the present invention.

### DETAILED DESCRIPTION OF THE INVENTION

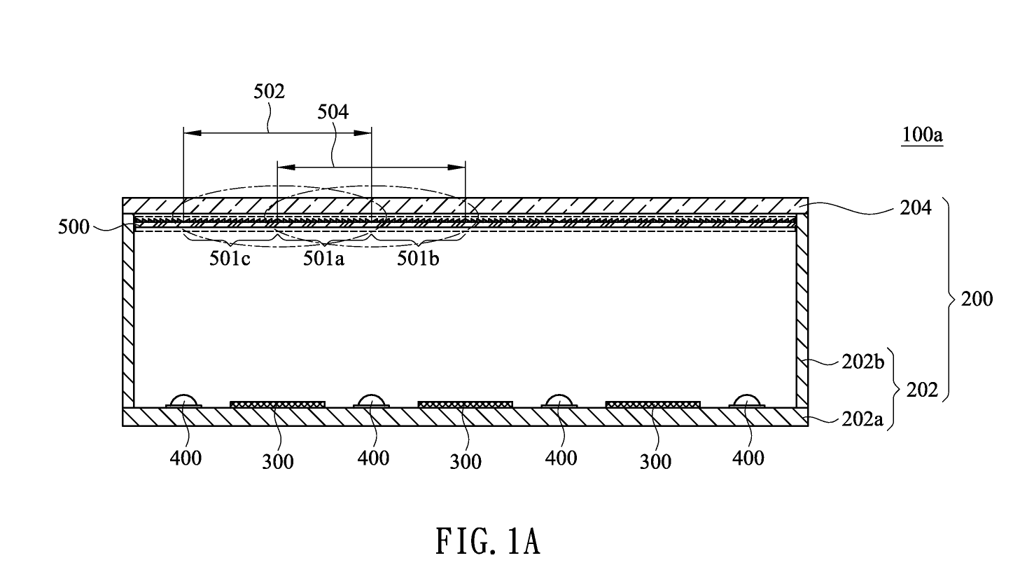

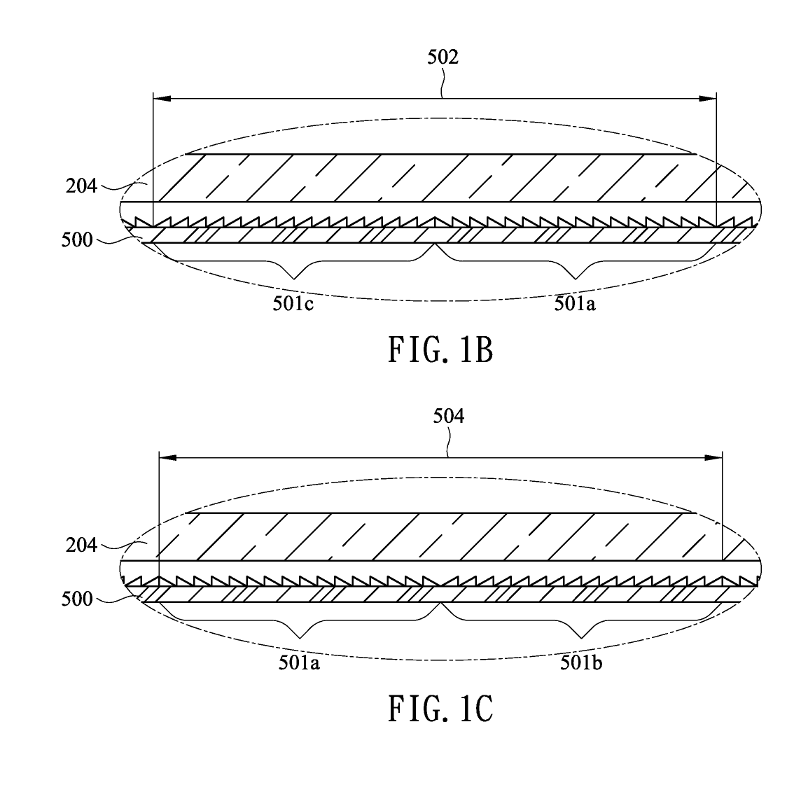

As shown in FIG. 1A, the embodiment is a solar energy ground light structure 100a, which comprises: a shell 200, one or more solar energy plates 300, a plurality of light-emitting diodes 400 and an optical film plate 500. Therein, the optical film plate 500 is deposited in the shell 200.

Still referring to FIG. 1A, the shell 200 is composed of a body 202 and a pervious-to-light cover 204, which jointly define an accommodating space. The pervious-to-light cover 204 serves to isolate the solar energy plates 300 and the light-emitting diodes 400 from the exterior so as to protect the solar energy plates 300 and the light-emitting diodes 400 from rain water, external impact or variable ambient temperature that may damage the components thereof. The pervious-to-light cover 204 may be made of glass, tempered glass, acrylic, polycarbonate or polyethylene. Therein, polycarbonate is often used in general bullet-resistant glazing. In addition to the materials recited above, for better rate of transmission, the pervious-to-light cover 204 may be also made of high-transmittance glass, high-transmittance tempered glass, high-transmittance acrylic, high-transmittance polycarbonate, high-transmittance polyethylene or other applicable high-transmittance materials.

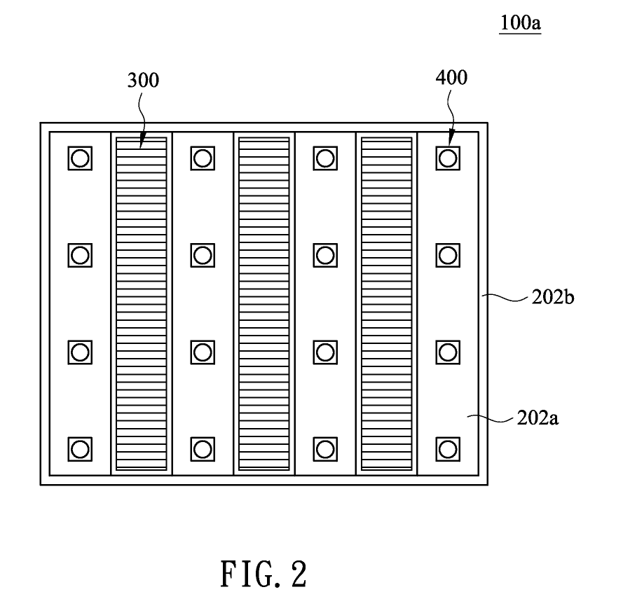

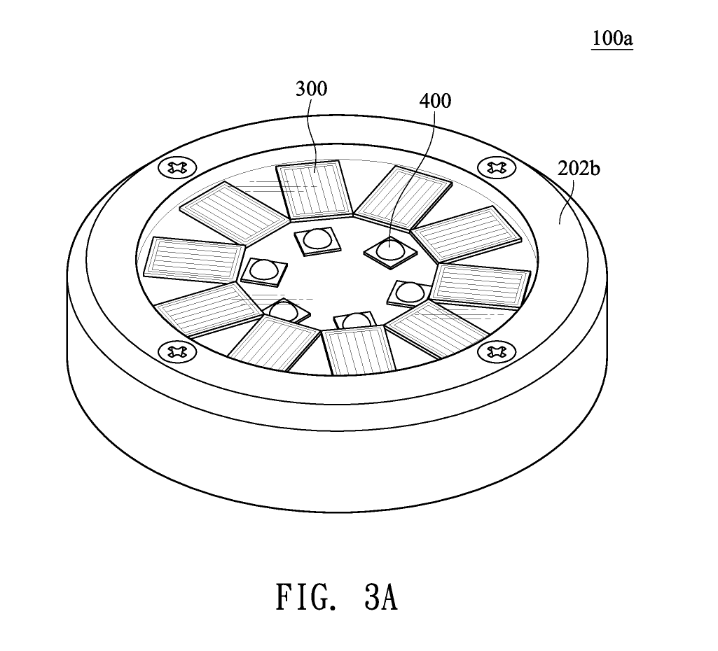

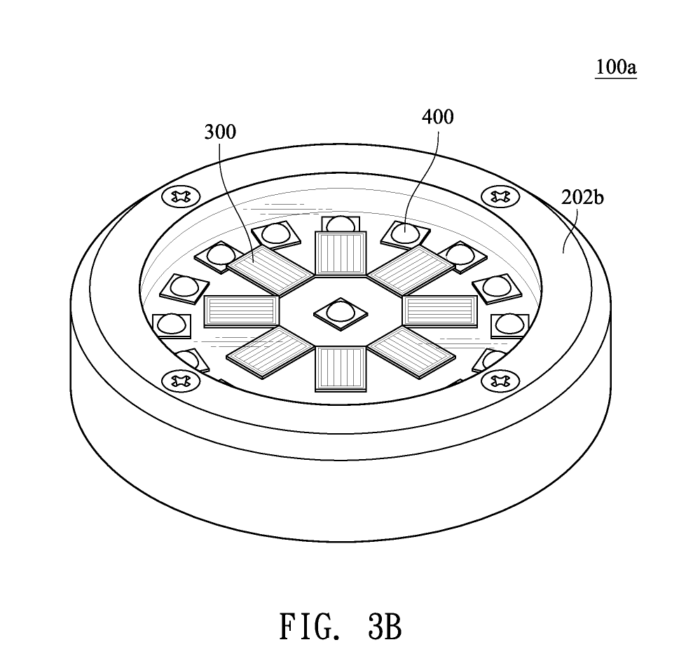

Also in FIG. 1A, the body 202 has a bottom plate 202a and a lateral plate 202b. The solar energy plates 300 and the light-emitting diodes 400 are alternately arranged on the bottom plate 202a. In the present invention, the arrangement of the solar energy plates 300 and the light-emitting diodes 400 is not limited and subject to change according to practical needs. In other words, the solar energy ground light structure 100a may be designed to have different shapes so that the arrangement of the solar energy plates 300 and the light-emitting diodes 400 may be modified to optimize the implement of the present invention. For example, the solar energy plates 300 and the light-emitting diodes 400 may be lined up and arranged alternately as an array as shown in FIG. 2, or, the solar energy plates 300 and the light-emitting diodes 400 may be alternately arranged into a circle, as shown in FIG. 3A or FIG. 3B.

Referring back to FIG. 1A, the optical film plate 500 has a plurality of light-converging areas 502 and a plurality of light-diffusing areas 504. Therein, each said light-converging area 502 is corresponding to a respective said solar energy plate 300, while each said light-diffusing area 504 is corresponding to a respective said light-emitting diode 400. As can be seen clearly in FIG. 1A, the light-converging areas 502 overlap adjacent said light-diffusing area(s) 504. More particularly, each said solar energy plate 300 is positionally corresponding to a center of a respective said light-converging area 502, while each said light-emitting diode 400 is positionally corresponding to a center of a respective said light-diffusing area 504. It is to be noted that, in the present drawings, the optical film plate 500, the solar energy plates 300 and the light-emitting diodes 400 are not made to scale and only for the purpose of illustrating the relative positions thereamong.

Referring to FIG. 1A through FIG. 1C, in virtue of the special lens designs of the light-converging areas 502 and the light-diffusing areas 504, the light-converging areas 502 are capable of converging solar light beams to the centers of the light-converging areas 502 for excellent light-converging capacity, and the light-diffusing areas 504 are capable of diffusing the light beams with an expanded light-emitting angle that improves the illumination area and the uniformity of the emitting light.

Still referring to FIG. 1A through FIG. 1C, the special lens designs of the optical film plate 500 may be materialized as a plurality of prisms that are settled abreast, wherein several said prisms jointly form a prism unit 501a, 501b, or 501c. As shown in FIG. 1A, each of the prism units 501a, 501b, 501c is arranged in bilateral symmetry with respect to the adjacent one said prism units 501a, 501b or 501c.

More particularly, as shown in FIG. 1B and FIG. 1C, any said prism unit 501a has two sides defined as a bottom corner and a lateral, respectively. The prism unit 501b adjacent to the bottom corner of the prism unit 501a is next to an apex of the bottom corner and extends in bilateral symmetry with respect to the prism unit 501a against an axis of symmetry perpendicular to the optical film plate 500 (as shown in FIG. 1C). The prism unit 501c adjacent to the lateral of the prism unit 501a extends in bilateral symmetry with respect to the prism unit 501a against the lateral (as shown in FIG. 1B). The prism units 501c and the prism units 501b may have identical configuration.

Therein, as shown in FIG. 1B, each pair of the prism units 501a, 501c forms a said light-converging area 502. Referring back to FIG. 1A, each of the solar energy plates 300 is corresponding to the center of a respective said light-converging area 502, so that incident light beams are processed by the prism units 501a, 501c and converged on the solar energy plate 300, thereby improving the light-converging capacity of the solar energy plate 300 and enhancing the light-converging utilization rate. As shown in FIG. 1C, each pair of the prism units 501a, 501b forms a said light-diffusing area 504. Referring back to FIG. 1A, each of the light-emitting diodes 400 is corresponding to the center of a respective said light-diffusing area 504, so that light beams emitted by the light-emitting diodes 400 are processed by the prism units 501a, 501b, thereby improving the uniformity of the emitting light.

It is to be noted that the arrangement of the light-converging areas 502 and the light-diffusing areas 504 is subject to arrangement of the solar energy plates 300 and the light-emitting diodes 400. Thus, when the solar energy plates 300 and the light-emitting diodes 400 are configured differently, the light-converging areas 502 and the light-diffusing areas 504 on optical film plate 500 need to be modified accordingly.

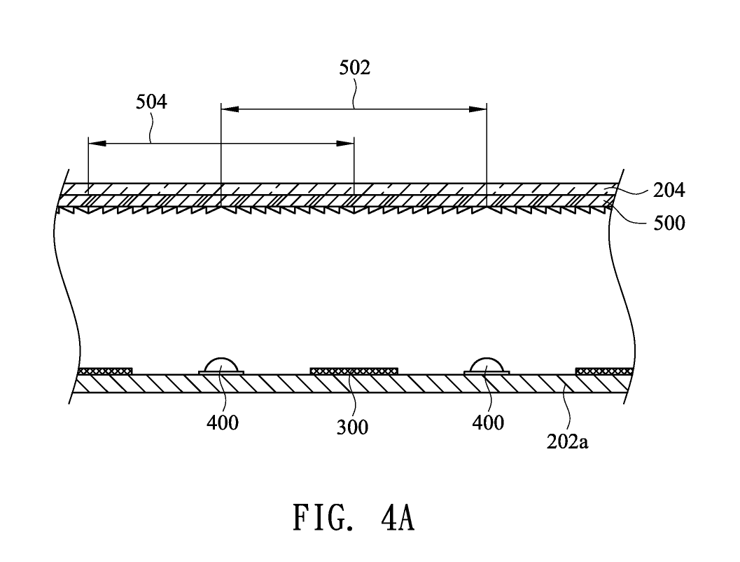

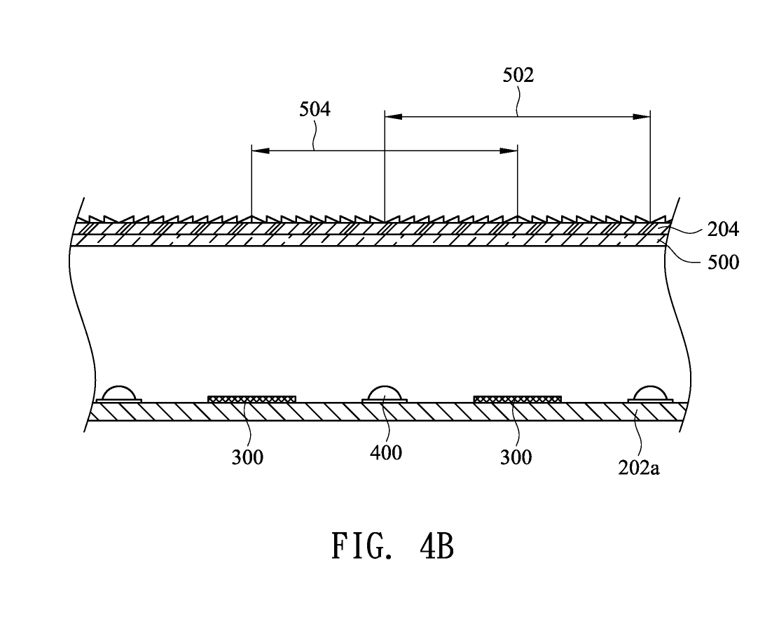

The location of the optical film plate 500 may be changed according to practical needs. As shown in FIG. 1A, the optical film plate 500 is settled between the pervious-to-light cover 204 and the solar energy plates 300 as well as the light-emitting diodes 400. However, in another embodiment, the optical film plate 500 may be combined with the pervious-to-light cover 204. As shown in FIG. 4A, the optical film plate 500 is combined with an inner surface of the pervious-to-light cover 204. Alternatively, the optical film plate 500 may be combined with an outer surface of the pervious-to-light cover 204, as shown in FIG. 4B.

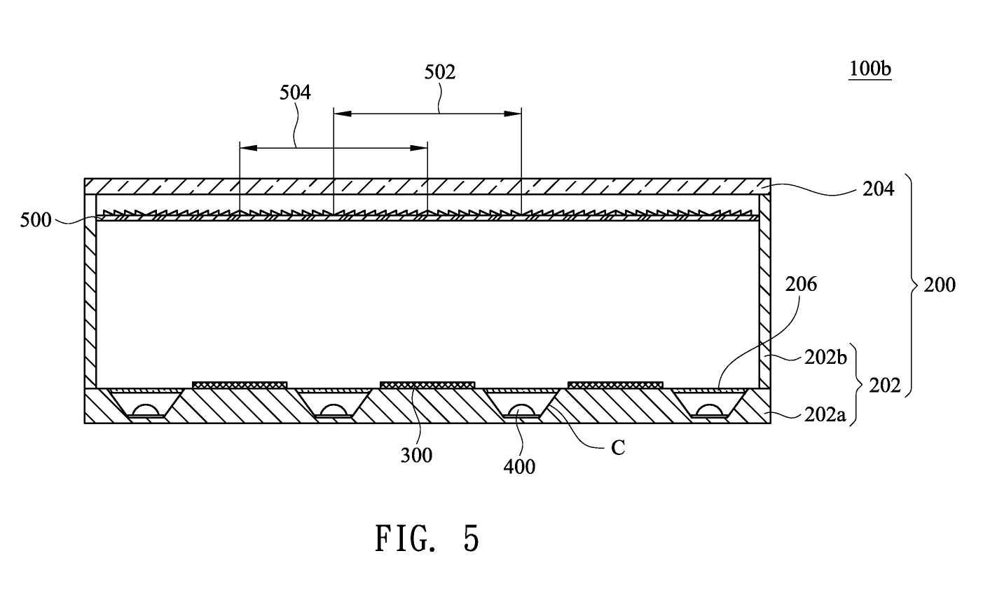

Referring to FIG. 5, in another embodiment, the bottom plate 202a of the solar energy ground light structure 100b is provided with a plurality of recesses c, for the light-emitting diodes 400 to be received therein. Furthermore, each said light-emitting diode 400 is provided with a diffusion plate 206 in a light-emitting path thereof. The diffusion plate 206 serves to expand the light-emitting angle of the light-emitting diode 400. By the diffusion plates 206, the light-emitting angle and light-illumination area of the light-emitting diodes 400 can be adjusted, thereby improving the uniformity of the emitting light.

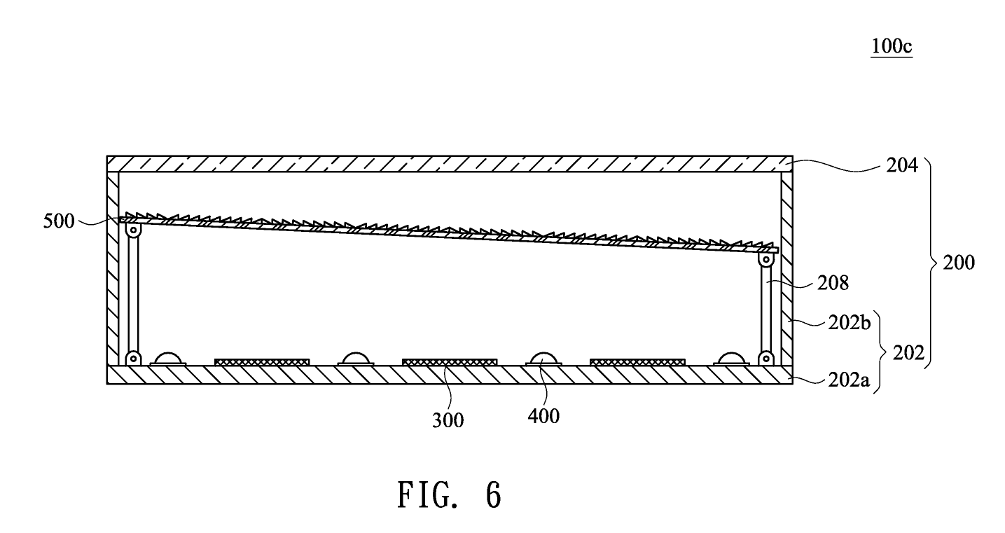

As shown in FIG. 6, in yet another embodiment, the solar energy ground light structure 100c further includes a first angle-adjusting element 208, which is arranged between the optical film plate 500 and the bottom plate 202a for adjusting a tilt angle of the optical film plate 500. The first angle-adjusting element 208 serves to change the angle where light beams come into the optical film plate 500, so as to maintain the incident light beams as perpendicular as possible to the optical film plate 500, thereby ensuring optimal light-converging efficiency. The first angle-adjusting element 208 may be implemented together with the recesses c shown in FIG. 5 and the foregoing diffusion plate 206 (not shown here), so as to enhance the light-converging capacity and improve the uniformity of the emitting light.

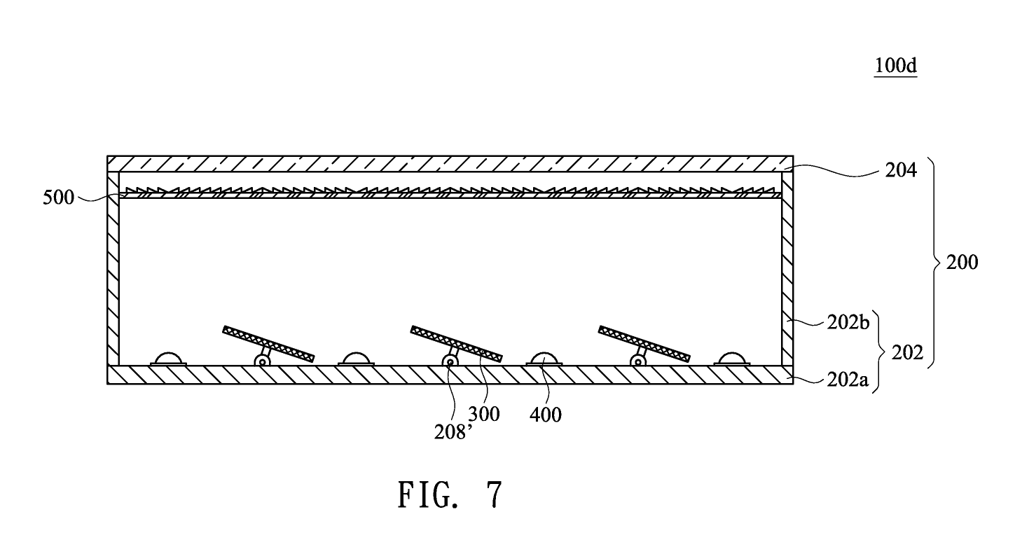

As shown in FIG. 7, the solar energy ground light structure 100d may further comprise a second angle-adjusting element 208′ between each said solar energy plate 300 and the bottom plate 202a for changing a tilt angle of the solar energy plate 300. The second angle-adjusting element 208′ functions similarly to the first angle-adjusting element 208 as shown in FIG. 6, except that each of the second angle-adjusting elements 208′ is provided between a respective said solar energy plate 300 and the bottom plate 202a, so as to allow the tilt angle of each of the solar energy plates 300 to be changed independently, thereby maintaining the incident light beams as perpendicular as possible to the solar energy plates 300.

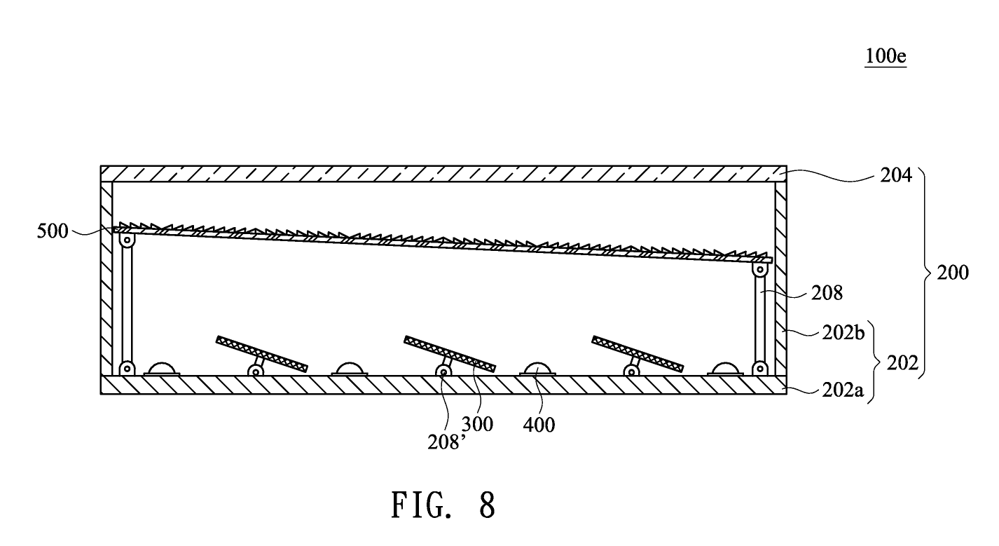

Alternatively, as shown in FIG. 8, the solar energy ground light structure 100e may have both the first angle-adjusting element 208 and the second angle-adjusting elements 208′, for changing the tilt angles of the optical film plate 500 and the solar energy plates 300, respectively. Hence, according to different ambient conditions, the tilt angles of the optical film plate 500 and the solar energy plates 300 can be properly adjusted, so as to improve the light-converging capacity and allow the incident light beams enter the solar energy plates 300 as perpendicularly as possible.

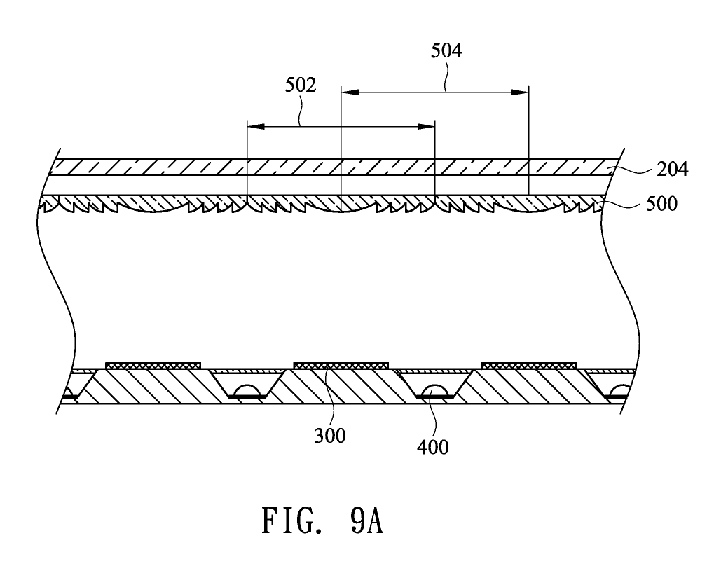

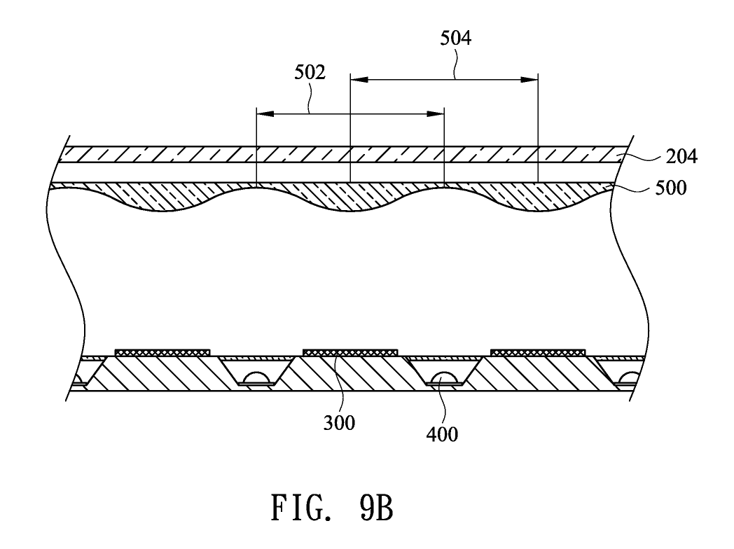

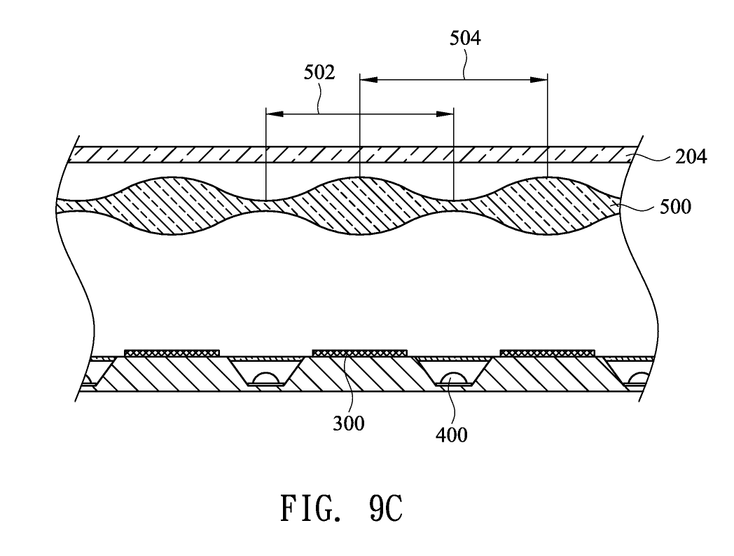

Moreover, the special lens designs of the optical film plate 500, in addition to the plurality of prisms as described previously, may be a plurality of Fresnel lenses, as shown in FIG. 9A, wherein each of the Fresnel lenses forms a said light-converging area 502 positionally corresponding to a said solar energy plate 300, and a part of each two adjacent said Fresnel lenses forms a said light-diffusing area 504 positionally corresponding to a said light-emitting diode 400.

Referring to FIG. 9B and FIG. 9C, the special lens designs of the optical film plate 500 may alternatively include a plurality of convex lenses and concave lenses, which may be formed on one surface of the optical film plate 500 (as shown in FIG. 9B), or on both surfaces of the optical film plate 500 (as shown in FIG. 9C). Therein, the convex lens or the biconvex lens has a center thereof corresponding to a respective said solar energy plate 300 and forms a said light-converging area 502, while the concave lens or the biconcave lens has a center thereof corresponding to a respective said light-emitting diode 400 and forms a said light-diffusing area 504.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A solar energy ground light structure, comprising:
a shell composed of a body and a pervious-to-light cover with an accommodating space defined therein, wherein the body has a bottom plate and a lateral plate;
at least one solar energy plate and a plurality of light-emitting diodes alternately arranged on the bottom plate; and
an optical film plate settled in the shell and having a plurality of light-converging areas and a plurality of light-diffusing areas,
wherein each said light-converging area is corresponding to a respective said solar energy plate while each said light-diffusing area is corresponding to a respective said light-emitting diode.

2. The solar energy ground light structure of claim 1, wherein the pervious-to-light cover is made of glass, tempered glass, acrylic, polycarbonate or polyethylene.

3. The solar energy ground light structure of claim 1, wherein the pervious-to-light cover is made of high-transmittance glass, high-transmittance tempered glass, high-transmittance acrylic, high-transmittance polycarbonate or high-transmittance polyethylene.

4. The solar energy ground light structure of claim 1, wherein the solar energy plates and the light-emitting diodes are lined up and arranged alternately as an array.

5. The solar energy ground light structure of claim 1, wherein the solar energy plates and the light-emitting diodes are alternately arranged into a circle.

6. The solar energy ground light structure of claim 1, wherein the optical film plate is combined with an outer surface of the pervious-to-light cover.

7. The solar energy ground light structure of claim 1, wherein the optical film plate is combined with an inner surface of the pervious-to-light cover.

8. The solar energy ground light structure of claim 1, wherein the optical film plate is settled between the pervious-to-light cover and the solar energy plates as well as the light-emitting diodes.

9. The solar energy ground light structure of claim 1, wherein the bottom plate has a plurality of recesses for receiving the light-emitting diodes therein and each said light-emitting diode is provided with a diffusion plate in a light-emitting path thereof.

10. The solar energy ground light structure of claim 1, further comprising a first angle-adjusting element provided between the optical film plate and the bottom plate for changing a tilt angle of the optical film plate.

11. The solar energy ground light structure of claim 1, further comprising a second angle-adjusting element provided between each said solar energy plate and the bottom plate for changing a tilt angle of the solar energy plate.
